(19) United States
(12) Patent Application Publication
(10) Pub. No.: US 2011/0053690 A1
(43) Pub. Date: Mar. 3, 2011

(54) Wii console controller fitting with refractive mirror

(75) Inventor: Kwok Kee CHONG, Hong Kong (HK)

(73) Assignee: Qualtech Global Ltd., Hong Kong (HK)

(21) Appl. No.: 12/550,424

(22) Filed: Aug. 31, 2009

(51) Int. Cl. G06F 17/00

(52) U.S. Cl. 463/37

(57) ABSTRACT

The present utility model proposes a Wii console controller fitting with refractive mirror. Through setting refractive mirrors in the front of the controller, infrared ray is transmitted to the infrared receiver of Wii console controller through the bottom receiving port of the fitting after refraction, thus to avoid the blockage of infrared ray receiving and, increase the accuracy of control and interest; moreover, to configure different game accessories in the front of the controller fitting to imitate different game tools such as sword, tennis racket and baseball bat, in this way to increase interest of the game and practicability of the controller.

### FIELD OF TECHNOLOGY

The present utility model relates to the field of game consoles, and more especially, to a controller fitting with refractive mirrors for Wii console.

### BACKGROUND OF THE TECHNOLOGY

Wii is a well-known representative of the “motion sensing games” presently, ranging from ball games, sports, combat games, wars and even cooking, etc. To increase the interest of playing and the vicarious sense, the market launched various controller fittings, such as racket, sword and gun; these fittings have the following in common: insert the controller into the fitting handle for application. The controller is operated in a wireless manner. The player inputs commands through controller, including pressing the buttons, or swinging the controller (for instance: when playing table tennis, the player holds the controller to imitate the movement of swinging a bat). The infrared receiver in front of the console controller receives the infrared ray to determine the position of the pointer appears on the TV screen.

However, the existing design for the fitting in the market is as below: when the controller is inserted in the fitting handle, the infrared receiving port at the front end of the controller is often blocked, leading to interference of infrared ray receiving and weakened the signal, thus delaying the infrared reception of the console controller and reducing the interest of playing.

### SUMMARY OF THE UTILITY MODEL

The present utility model aims at providing a Wii console controller fitting with refractive mirror by overcoming the defects existent in the existing technology so as to avoid the interference of infrared ray receiving and the delaying of infrared receiving of the console controller, thus increasing the accuracy of control and interest for the games.

The technical solution for the present utility model is as below:

A console controller fitting with refractive mirror, comprising the Wii console controller fitting with refractive mirror and the Wii console controller for receiving infrared ray, the controller is set in the fitting handle, wherein refractive mirrors are set in the front of the controller for refracting infrared ray and then the console transmits the infrared ray to the infrared receiver of Wii console controller through the bottom receiving port of the fitting.

According to the aforesaid technical characteristics, there are two such refractive mirrors.

For the present utility model, different game accessories can be configured in the front of the controller fitting to imitate different game tools.

The present utility model can achieve the following useful purposes: the Wii console controller fitting with refractive mirror adopting the present utility model is provided with refractive mirrors in the front of the controller. Therefore, infrared ray is transmitted to the infrared receiver of Wii console controller through the bottom receiving port of the fitting after refraction, thus avoiding the blockage of the infrared ray receiving and delay reception of the infrared ray by the console controller, increasing the accuracy of control and interest; moreover, configuring different game accessories in the front of the controller fitting to imitate different game tools such as a sword, tennis racket and baseball bat, in this way to increases the interest and practicability of the controller.

### DESCRIPTION OF THE DRAWINGS

FIG. 1 is the schematic view of the structure of the fitting provided by the embodiment of the present utility model (sectional);

FIG. 2 is the schematic view of the structure of the fitting provided by the embodiment of the present utility model (exploded);

FIG. 3 is the working principle diagram of fitting provided by the embodiment of the present utility model.

### DETAILED DESCRIPTION OF THE EMBODIMENTS

See the drawings attached

The present utility model proposes a Wii console controller fitting with refractive mirror. Through setting refractive mirrors in the front of the controller, infrared ray is transmitted to the infrared receiver of Wii console controller through the bottom receiving port of the fitting after refraction, thus avoiding the blockage of the infrared ray receiving and delay reception of the infrared ray by the console controller, increasing the accuracy of control and interest. To make the purposes, technical solution and advantages of the present utility model clearer, the present utility model is further detailed hereinafter in combination with the drawings and embodiments.

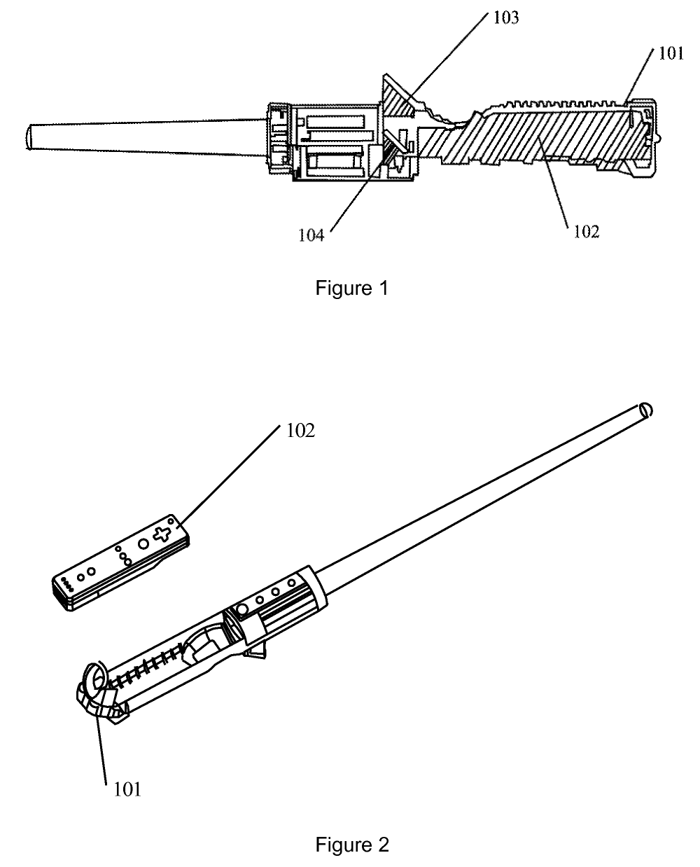

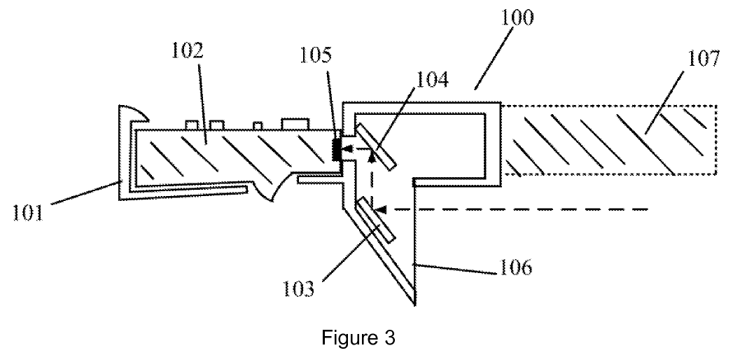

As shown in FIG. 1 and FIG. 2, the embodiment of the present utility model provides a console controller fitting with refractive mirror used for a Wii game console controller, wherein the controller 102 is inserted in the handle 101 of the fitting 100. The controller 102 is operated in a wireless manner. The controller 102 is used by the user, including pressing the buttons, or swinging the controller 102 (for instance: when playing table tennis, the player holds the controller 102 to imitate the movement of swinging a bat). In this embodiment, the fitting 100 is provided with the first refractive mirror 103 for refracting infrared ray and the second refractive mirror 104 for the same purpose, both refractive mirrors 103, 104, set in the front of the infrared receiver 105 which is in the front of the controller 102, cooperate mutually, the infrared ray transmit through the bottom receiving port 106 of the fitting 100, the first refractive mirror 103 refracts the infrared ray to the second refractive mirror 104 and then the refractive mirror 104 refracts the infrared ray to the infrared receiver 105 of the Wii console controller 102. The refraction of the infrared ray is in dotted line with the arrows as shown in FIG. 3. The receiver 105 receives infrared ray which is received through the bottom receiving port 106 of the fitting 100 after refraction, thus avoiding the blockage of the infrared ray receiving and delay reception of the infrared ray by the console controller, increasing the accuracy of control and interest.

The game accessory 107 of the fitting 100 can be in any shape (such as a bat, a weapon) to suit different games.

It shall be noted that, the abovementioned embodiment is only applied to illustrate, but not limit, the technical solution of the present utility model. Although the present utility model is detailed by referring to the preferred embodiment, those skilled in the art shall understand that the revisions or equivalent replacements to the technical solution without deviating from the spirit or scope of the technical solution of the present utility model shall be within the scope defined by the claims for the present utility model.

1. A Wii console controller fitting with refractive mirror, comprising the Wii console controller fitting with refractive mirror and a Wii console controller for receiving infrared ray, wherein the controller is set in the fitting handle, characterized in that the fitting is provided with refractive mirrors in the front of the controller for refracting infrared ray and then the Wii console transmits the infrared ray to the infrared receiver of Wii console controller through the bottom receiving port of the fitting.

2. The Wii console controller fitting with refractive mirror according to claim 1, characterized in that there are two such refractive mirrors.

3. The Wii console controller fitting with refractive mirror according to claim 1, characterized in that different game accessories can be configured in the front of the controller fitting at will.
